(19) United States
(12) Patent Application Publication
(10) Pub. No.: US 2007/0163705 A1
(43) Pub. Date: Jul. 19, 2007

(54) Process for producing versatile plastic products having a preferentially abrasion-resistant surface

(75) Inventors: Thilo Dollase, Hamburg (DE); Klaus Keite-Telgenbuscher, Hamburg (DE); Aranzazu Escudero Vallejo, Hamburg (DE); Stefan Stadler, Hamburg (DE); Carsten Blank, Tostedt (DE)

Correspondence Address: Kurt G. Briscoe;Norris, McLaughlin & Marcus P.A., 18th Floor, 875 Third Avenue, New York, NY, 10022, US

(73) Assignee: tesa Aktiengesellschaft, Hamburg (DE)

(21) Appl. No.: 11/369,078

(22) Filed: Mar. 6, 2006

(30) Foreign Application Priority Data
Jan. 18, 2006 (DE) 10 2006 002 595.4

(51) Int. Cl. B32B 37/00

(52) U.S. Cl. 156/247

(57) ABSTRACT

The invention relates to a process for producing versatile plastic products, preferably single-sidedly self-adhesive products bearing an abrasion-resistant and flexible protective layer which is distinguished by particularly high surface quality especially in terms of its optical properties.

The invention relates to a process for producing versatile plastic products, preferably single-sidedly self-adhesive products bearing a preferentially abrasion-resistant and flexible protective layer which is distinguished by particularly high surface quality especially in terms of its optical properties.

### PRIOR ART

Plastics are long-established materials for diverse applications and are presently employed in a wide variety of forms such as components, lining elements, and for glazing systems. In many sectors they have replaced conventional materials such as metal, wood, ceramic or silicate glasses in these applications. Certain applications, moreover, would not be practicable at all without plastics. The success story of plastics is without doubt founded in one part on their extremely simple processing. Films, sheets and profiles can be produced advantageously in continuous operations by means, for example, of extrusion. Elements with more complicated geometry can be realized by means of injection-moulding techniques, for example. Shaping methods can be carried out at comparatively low temperatures. Further advantages include the reduced weight as compared with conventional raw materials. In spite of these advantages, however, plastics, depending on their type, also have potential for improvement in specific applications. With plastics, generally speaking, the ageing stability and, more generally, the resistance to external influences does not match that of many conventional materials. Attempts to obtain improved plastic-based materials, in terms of the ageing behaviour, include the use of additives, such as ageing inhibitors, antioxidants and UV protectants. An alternative path to optimizing plastic-based materials and to making them useful for an even broader assortment of applications is to coat the surfaces of the workpieces with a protective varnish. This variant is particularly appropriate when the workpieces are to be made more robust towards a different kind of external influences, namely the mechanical stressing of their surface by abrasion or scratching.

For equipping plastic substrates for resistance to such mechanical stresses there are a multiplicity of varnish systems available, from a range of suppliers. The majority of the varnish formulas available are thermally curable. Hence it is possible to cure coatings fully even on three-dimensional structures with a surface of complex design. In the course of such curing, however, the cure temperatures must not exceed the upper temperature stability limit of the plastic substrates, and depending on type of plastic and cure mechanism this is not always possible.

In order to get around this problem, therefore, varnish formulas were developed which can be cured by irradiation, particularly by irradiation with ultraviolet radiation or by means of electron beams. One example of applications for polycarbonate substrates is given in U.S. Pat. No. 4,198,465 by General Electric. A curing operation of this kind generally proceeds at relatively low temperatures, so that the thermal load on the plastic substrates is substantially lower than will be the case when using thermosetting protective varnish systems. A further advantage of the radiation curing of varnishes lies in its ease of implementation in continuous operations, particularly for substrates in web form. An overview of the technology of radiation-curable varnishes and diverse possibilities for use can be gained by studying reviews, which are found for example in Dowbenko and colleagues [R. Dowbenko, C. Friedlander, G. Gruber, P. Prucnal, M. Wismer, Progr. Org. Coat., 1983, 11, 71], in Holman and Oldring [R. Holman, P. Oldring (ed.), UV and EB Curing Formulations for Printing Inks, Coatings and Paints, 2nd ed. 1988, SITA-Technology, London], in a multi-volume work by Oldring [P. Oldring (ed.), Chemistry & Technology of UV & EB Formulations for Coatings, Inks & Paints, 1991, SITA-Technology, London] or in C. Decker [C. Decker in Materials Science and Technology, R. W. Cahn, P. Hansen, E. J. Kramer (ed.), Volume 18, 1997, Wiley-VCH, Weinheim].

In addition to the shaped articles exemplified above, plastics find broad application, in a further design form, as sheets, which are used for example in the packaging sector or for masking surfaces, whether for decorative reasons or protective purposes, or as base materials for self-adhesive products. In these instances there may likewise be a desire to optimize the resistance of the side exposed to the environment—that is, the part of the sheet exposed to a particularly great extent to external influences—towards, for example, mechanical loading such as abrasion or scratching. Here too, the use of protective varnishes is appropriate.

A range of documents describe radiation-curable varnish formulations which are employed for coating plastic sheets. What these formulations typically have in common is the presence in the formula of at least one variety of a polyfunctional (meth)acrylate. By exposure to appropriate radiation, initiated by photoinitiators in the case of UV curing, these (meth)acrylated monomers, oligomers or polymers are incited to polymerization, producing a close-meshed network. The formulas may include various other kinds of constituents. Inorganic particles, in particular, have been described as possibilities for advantageous use with respect to higher varnish-film hardnesses. Examples of radiation-curable varnish formulations are found in U.S. Pat. No. 4,557,980 to Martin Processing Inc., in U.S. Pat. No. 4,319,811 to GAF Corp., in EP 50 996 B1 to Mitsui Petrochemical, in U.S. Pat. No. 4,310,600 to American Hoechst Corp., in JP 01 266 155 to Sunstar, and in U.S. Pat. No. 5,104,929 to 3M.

Nowadays there are different sheet-form products known which in accordance with their description have been or can be provided with protective varnishes. The function of the protective varnish in the case of these products is to make the sheet material itself, or further functional layers present thereon, more resistant to external influences. Examples are disclosed in U.S. Pat. No. 6,440,551 by CPFilms and also in U.S. Pat. No. 6,329,041 and U.S. Pat. No. 6,638,606 by Dai Nippon Printing.

There nevertheless continues to be a need for processes allowing the production of products with universal utility (as special single-sidedly self-adhesive products, where appropriate), provided with an abrasion-resistant and flexible varnish layer and notable for high optical quality. Single-sidedly self-adhesive products may, for example, be articles for temporary, long-lasting or permanent fixing to substrates, such as, in particular, self-adhesive decorative sheets, self-adhesive information-carrying products or self-adhesive data storage products, where the visual impression of the decoration, the legibility of the information or the functionality of the data storage in respect of data legibility and/or data writeability is to be ensured over a long period of time despite mechanical stressing of the surface. The group of single-sidedly self-adhesive products of this kind which are furnished with an abrasion-resistant and flexible varnish layer also includes protective sheets which can be used to enhance sensitive and valuable surfaces and, in doing so, are intended to maintain maximum optical surface quality not only of the surface to be protected but also of the protective sheet itself, for as long a time as possible and in spite of external mechanical loading.

For the production of the single-sidedly self-adhesive products exemplified above it is the case that a layer of protective varnish can be applied to a precursor material, preferably in sheet form, in such a way that the requirement for particularly high optical quality on the part of this optical protective varnish layer is met. This requires, on the one hand, special varnish formulations, and on the other hand, in particular, special coating and curing methods which are in tune with these demanding requirements.

One advantage of radiation-curable coating formulations lies in the possibility of complete renunciation of solvent. In that case, however, depending on the viscosity and composition of the varnish formulation, the quality of the coating pattern depends in some cases greatly on the nature of the coating method. Structures in the varnish surface, which originate from the coating equipment and have their cause in deficient flow on the part of the liquid varnish layer, are typically not tolerated in the case of high-value products for demanding applications. There is therefore a demand for processes for applying varnish layers with high surface quality, and in particular without any unwanted traces of the coating equipment in or on the varnish layer, to a sheet-form base.

A further point critical for the quality of the varnish film under production is, furthermore, the curing step. In order to ensure efficient varnish curing it is necessary to ensure that the varnish layer also actually undergoes complete curing. A successful outcome depends, of course, on the dose of the radiation employed. Since arbitrarily high radiant outputs are not available, this limits the web speed and hence the amount of product produced per unit time. The search is therefore on for, firstly, formulas which react particularly quickly under radiation exposure and, secondly, in particular, methods which allow accelerated operation. A negative effect on productivity is exerted generally by all influencing variables which lead to reduced reactivity of the varnish formulation. A particularly important variable in this context is the influence of atmospheric oxygen, particularly in the case of thin films such as may occur when varnish-coating substrates such as plastic sheets.

Like all free-radical polymerization processes, the radiation-induced curing of radiation-curable varnish formulations, too, is disrupted by the presence of molecular oxygen such as is present in ambient air. Curing then proceeds more slowly or only incompletely. As a consequence, the quality of the varnish layer suffers, in respect for example of its surface hardness, or manufacture cannot be carried out at optimum speed.

Various possibilities have been proposed in the literature as to how the negative effect of atmospheric oxygen on the curing process can be suppressed.

Thus, for example, it is known that oxygen can be kept away from the curing film by using flat substrates. EP 50 996 B1 of Mitsui Petrochemical, for example, cites the use of a polyester sheet, Peinado and colleagues the use of LDPE sheets [C. Peinado, E. F. Salvador, A. Alonso, T. Corrales, J. Baselga, F. Catalina, J. Polym. Sci. A-Polym. Chem., 2002, 40, 4236] and Studer et al. the use of a polypropylene sheet [K. Studer, C. Decker, E. Beck, R. Schwalm, Progr. Org. Coat., 2003, 48, 92]. In all of these cases use is made of protective sheets whose degrees of quality in respect of surface roughness are unsatisfactory. A sheet surface leading to a varnish surface is not sufficient in high-value applications to meet the exacting requirements for surface smoothness, although the human eye perceives the varnish surface to be glossy. In high-value applications of this kind the requirement is instead for surface qualities which are reproduced in a substantially more precise way by means, for example, of the Rz value (see, for example, DIN EN ISO 4287), which characterizes the profile of the surface roughness of a varnish layer or of a sheet, and which for such demanding applications can be situated in the region of less than 100 nm.

For the preferably single-sidedly self-adhesive products exemplified above, for example, the requirement that a surface be made abrasion-resistant is not the only requirement; instead, it is also necessary for the visual impression, which is determined by, among other things, the surface nature of the abrasion-resistant varnish, to be of high-grade quality. Thus in these cases there is a particular desire for the surface to have an excellent smoothness, in other words a particularly low surface roughness and a particularly pronounced gloss, and hence an extremely low turbidity (haze). Consequently it is necessary, in terms of the process design selected for coating and curing, not only to carry out optimization with regard to the curing characteristics of the varnish layer but also to ensure that, after the curing step, a coated sheet product is obtained which has a flawless surface quality.

### OBJECT OF THE INVENTION

The object on which the invention was based was therefore to provide processes via which plastic products, especially sheet webs, can be provided with a protective layer of varnish, the products obtained being notable for outstanding surface quality on the varnish side.

### ESSENCE OF THE INVENTION

The object can be achieved with advantage by means of a specific process for coating versatile plastic products, especially sheet-form materials, using abrasion-resistant and flexible protective varnishes. On the one hand, a high cure rate is ensured by substantial exclusion of atmospheric oxygen from the curing varnish layer, and on the other hand, at the same time, the process leads to extremely high surface quality of a curing varnish layer. The process of the invention is characterized in that, following the coating operation, an as yet uncured varnish layer is laminated with a cover layer, for example a protective sheet of particular quality, through which the varnish layer is cured by—preferably—irradiation and which is removed again after curing has been completed. The cover layer employed possesses particular properties especially in respect of its surface roughness and optical quality. The process of the invention is set out in further detail in the description below, in the example and in the claims.

The process of the invention for producing versatile plastic products comprises the steps of
a) providing a base material coated with a protective layer in the form of a curable liquid varnish formulation,
b) covering it with a cover layer characterized by a low surface roughness at least to the varnish side, with an Rz value of not more than 0.3 μm, and/or by a low turbidity, with a haze value of not more than 5%,
c) curing the varnish layer through the cover layer, and
d) detaching the cover layer.

The base material, which is preferably in sheet form, has optionally been pretreated and/or possesses at least one further functional layer. The versatile plastic products are present preferably in webs with a working width of at least 30 cm, preferably at least 50 cm.

Optionally the plastic products have adhesive layers, preferably pressure-sensitive adhesive layers, which can be applied selectively to the end product or to a preliminary product. Particular preference is given to producing plastic products which comprise on one side at least one self-adhesive layer.

The products produced in accordance with the invention are distinguished by a varnish surface with particularly high abrasion resistance, combined with flexibility, and additionally exhibit further optical properties, such as anti-reflection, high or low refractive indices, etc. In addition to or alternatively to abrasion resistance they may comprise any desired functional coatings, which exhibit, for example, particular electrical, magnetic or electrooptical properties.

The present invention also provides in particular a process for producing single-sidedly self-adhesive products which have been provided with an abrasion-resistant and flexible protective layer and which are distinguished by particularly high surface quality especially with regard to their optical properties.

In accordance with the invention a liquid, radiation-curable varnish formulation is coated onto a preferably sheet-form base material and the cover layer is laminated onto the coated but as yet uncured varnish layer, which is cured through the cover layer preferably by irradiation. In accordance with the invention, specific cover layers are used as an oxygen barrier layer, via which it is possible for the covering to result in a varnish layer surface which is of a particularly high grade in optical terms. Irradiation through this layer leads not only to a solidification and hence preservation of the high-grade varnish surface but also, at the same time, to efficient curing of the varnish layer, since the presence of the cover layer keeps atmospheric oxygen, which is disruptive to curing, away from the reacting varnish layer. Cover layers which can be employed in accordance with the invention are distinguished by a particularly low surface roughness, by high transparency for the radiation used preferably for varnish curing, by a low haze value, and by their capacity for redetachment from the varnish surface without disruption or residue after curing. The process of the invention serves in particular for producing materials in web form with web widths of preferably at least 30 cm, very preferably at least 50 cm.

For the purposes of this invention it is possible to select in principle any of the methods known to the skilled worker for the coating of the base material, preferably a sheet-form material, through the varnish formulation. Without wishing to be bound by any restriction, mention may be made, by way of example, of knife-coating, blade, roller, spray, dip, brush, casting and printing methods, such as offset or flexographic printing methods, for example. Combinations of various methods are also conceivable in this case, such as, for example, the Mayer bar method, a coating process which combines rollers and knives with one another, or roll/casting systems, in which rollers and knives are combined with one another and, additionally, the principle of casting coating is incorporated. A number of coating methods which can be employed in accordance with the invention have been compiled, for example, by Scharenberg [R. T. Scharenberg in Encyclopedia of Polymer Science and Engineering, H. F. Mark, N. M. Bikales, C. G. Overberger, G. Menges (ed.), Volume 3, 2nd Ed., 1985, Wiley, New York]. One advantageous procedure utilizes the principle of engraved roll application. This can be implemented, for example, in direct gravure operation, where the engraved roll transfers the varnish formulation directly to the sheet-form material, or in offset gravure operation, where the engraved roll first passes the varnish to an offset roll which then transfers it to the sheet-form material. The placement of the varnish formulation onto the engraved roll takes place advantageously by means of a closed chamber knife or by immersion of the engraved roll in a trough, the amount of varnish on the surface of the engraved roll then being typically controlled in addition by a metal stripping plate.

Where rolls are employed in the operation of the invention, they may adopt, for example, the function of a metering roll, a transfer roll or a backpressure roll (back-up roll). Rolls of different kinds in terms of shell material and surface type can be used with advantage. Examples of rolls which can be employed in accordance with the invention are steel rolls, especially those of high-grade stainless or chromium-plated steel, rolls with surfaces of other metals, white cast iron rolls, ceramic rolls and rubber rolls (elastomer rolls). The elastomers employed in rubber rolls may be based for example on EPDM, polyurethane (PU), nitrile-butadiene rubber (NBR) or silicone rubber. Rolls may also have an anti-adhesive silicone or PTFE coating. Flat rolls are useful in just the same way as engraved rolls, which may be laser-engraved or etched and may have different engraved patterns such as square, hexagonal or hatching patterns. Optionally it is possible to use temperature-controllable rolls, i.e. rolls which can be cooled or heated. Rolls may be driven or may be used in freely flowing form, may run synchronously, and may also rotate in or counter to the web direction. Roll pairs, i.e. combinations of two rolls, which together form a roll nip, may be run co- or counter-rotatingly, and the rotational speed of the two rolls may be the same or different. The rolls selected may also have identical or different diameters. Other operating elements which can be used in the coating step in accordance with the invention include, for example, coating knives, air knives and metal stripping plates. Preference is given to using at least one engraved roll in the coating step.

The process of the invention for producing versatile plastic products further comprises a step in which the coated material in preferably sheet form is covered with a cover layer (a sheet, for example). For the inventive covering of the coated varnish layer With the layer used in accordance with the invention it is possible to employ any methods known to the skilled person. Appropriate methods include, in particular, all those known, for example, from the use of laminating sheets. H. Klein has compiled a number of laminating methods which can be employed in principle in the context of this invention [H. Klein, Coating, 1996, 29, 246]. Advantageously, a cover sheet is married at equal speed to a sheet-form material provided with a varnish coating, and the cover sheet is brought into contact with the coated sheet-form material through the use of a pressure roll. The pressure roll very preferably has a smooth surface. It is advantageous to operate with a linear pressure of the pressure roll. With great preference the contact pressure is just small enough to press out any air bubbles from the assembly. Where low contact pressures of this kind are required, the varnish layer can be covered using, advantageously, rubber rolls or other kinds of roll known to the skilled person, or devices of different design.

Where roll pairs consisting of pressure roll and lower roll are employed in the covering operation, the diameters of the two rolls may be the same or different and the surface type, in respect of material and/or structure, for example, may likewise be the same or different. The pressure roll may be driven or else may be implemented in a freely flowing form in the operation. Pressure roll and lower roll preferably run with the same angular velocity.

In contrast to typical laminating methods, in which composite sheets are produced, the cover sheet for the purposes of this invention is selected such that, after covering and after the curing of the varnish layer, the cover sheet can be removed from the varnish layer again without destruction or residue.

Cover sheets which can be used in accordance with the invention are notable for their high surface smoothness at least on the side facing the varnish, by high transparency in the wavelength range relevant for irradiation in at least one curing step, and by redetachability without destruction or residue from the cured varnish layer after irradiation.

A cover sheet can be employed in accordance with the invention when its side at least facing the varnish has a surface roughness as determined by test D with an Rz value of not more than 0.3 μm, preferably not more than 0.15 μm, very preferably not more than 0.08 μm.

In one specific embodiment of the invention, namely that employed when carrying out curing with UV radiation, the cover sheet is inventive when, with an irradiated wavelength of 400 nm, it has a transparency by test E of at least 80%, very preferably at least 85%. Where electron beams are used to cure the at least one varnish layer, the sheet need not be transparent at a wavelength of 400 nm and also in the visible region.

The cover sheets of the invention have haze values by test F of not more than 5%, preferably not more than 2.5%, very preferably not more than 1%.

Cover sheets of the invention preferably have a layer thickness of 5 μm und 150 μm each inclusive, preferably between 15 μm and 100 μm each inclusive.

Cover sheets of the invention are based advantageously on polyolefins. Preferred polyolefins are prepared from ethylene, propylene, butylene and/or hexylene, it being possible in each case to polymerize the single monomers or to copolymerize mixtures of the stated monomers. Through the polymerization method and through the selection of the monomers it is possible to control the physical and mechanical properties of the polymer sheet, such as the softening temperature and/or the tensile strength. A further possibility is to use polyvinyl acetates. In addition to vinyl acetate, polyvinyl acetates may also contain vinyl alcohol as a comonomer, with the free alcohol fraction being variable within wide limits. It is also possible for polyesters to serve as base material for the cover sheet of the invention. One particularly preferred embodiment of this invention uses polyesters based, for example, on polyethylene terephthalate (PET). Moreover, polymethacrylates can be used to produce cover sheets of the invention. In this case it is possible through the choice of monomers (methacrylates and in some cases acrylates as well) to control the glass transition temperature of the sheet. Furthermore, the polymethacrylates may also comprise additives, in order, for example, to increase the flexibility of the sheet or to raise or lower the glass transition temperature or to minimize the formation of crystalline segments. Further materials on which cover sheets useful in accordance with the invention may be based include partly fluorinated or perfluorinated polymeric hydrocarbons. Papers can also be employed.

Cover sheets of the invention may alternatively be in, in particular, monoaxially oriented, biaxially oriented or unoriented form.

To produce a material in sheet form it may be appropriate to add additives and further components which enhance the film-forming properties, reduce the tendency for crystalline segments to form and/or specifically improve the mechanical properties or else impair them where appropriate. As further additives which can be employed on an optional basis it is possible for ageing inhibitors, light stabilizers such as, in particular, UV protectants, antioxidants, further stabilizers, flame retardants, pigments, dyes and/or expandants to be present.

Cover sheets of the invention may be employed as a monolayer construction or else as a multilayer composite obtained, for example, by coextrusion, or else as a sheet laminate. Furthermore, cover sheets of the invention may also, on one and/or both sides, have been pretreated and/or provided with a functional layer. Where both sides have been pretreated and/or coated, the nature and/or extent of the pretreatment and/or coating may be different or the same. Such pretreatment and/or coating may result, for example, in improved redetachability from the at least one cured varnish layer. For this purpose it is particularly advantageous if the side pointing to the varnish bears a coating which is based on polysiloxanes, partly fluorinated or perfluorinated polymeric carbon compounds or polyolefins such as, in particular, polyethylene, and/or if it has been modified by corona and/or flame and/or plasma treatment and/or other methods of surface pretreatment.

The cover layers of the invention at least on the side facing the varnish layer are preferably free from inorganic and/or particulate antiblocking agents such as, for example, silicates or talc.

The process of the invention for producing the versatile plastic products further comprises at least one curing step. This at least one curing step is integrated into the process of the invention in such a way that it takes place after the coating of the varnish formulation from which, by crosslinking, the at least one abrasion-resistant and flexible varnish layer is obtained, and after covering with a cover layer of the invention. For the purposes of this invention, this end is accomplished by using, preferably, radiation-chemical methods. These include exposure to electromagnetic radiation such as, in particular, UV radiation, and/or to particulate radiation such as, in particular, electron beams. The coated varnish material is irradiated and thus cured by means of short-term exposure to light in a wavelength range between 200 to 500 nm and/or accelerated electrons. In the case of UV irradiation, use is made in particular of high-pressure or medium-pressure mercury lamps with an output of 80 to 240 W/cm. Further radiation sources which can be employed for the purposes of this invention are familiar to the skilled person. The emission spectrum of the lamp is tailored selectively to the photoinitiator employed, or the nature of the photoinitiator is adapted to the lamp spectrum. The irradiation intensity is adapted to the respective quantum yield of the UV photoinitiator and to the web speed.

Where irradiation with accelerated electrons is employed to cure the varnish layer, which can also be done in combination with UV crosslinking, typical irradiation equipment then includes linear cathode systems, scanner systems, or segmented cathode systems when electron beam accelerators are involved. Typical acceleration voltages are situated within the range between 50 kV and 1 MV, preferably 80 kV and 300 kV. The irradiation doses employed lie between 5 to 250 kGy, in particular between 20 and 100 kGy.

The products produced with the process of the invention are preferably single-sidedly self-adhesive products which include at least one pressure-sensitive adhesive layer. This at least one pressure-sensitive adhesive layer is composed of any prior-art pressure-sensitive adhesive (in this regard see, for example, D. Satas (ed.), Handbook of Pressure Sensitive Adhesive Technology, 2nd ed., 1989, Van Nostrand Reinhold, New York), and based in particular on acrylate, natural rubber, synthetic rubber or ethylene-vinyl acetate. Combinations of these and further systems are also in accordance with the invention. Very great preference is given to employing pressure-sensitive adhesives based on acrylate copolymers.

Examples of pressure-sensitive adhesives which can be employed in accordance with the invention are all polymers of linear, star, branched, graft or other architecture, preferably homopolymers, random copolymers or block copolymers. Examples that may be mentioned, though without wishing to undertake any restriction, of polymers which are particularly advantageous in the context of this invention include random copolymers starting from α,β-unsaturated esters and/or starting from alkyl vinyl ethers. Particular preference is given to using α,β-unsaturated alkyl esters of the general structure
CH₂═CH(R¹)(COOR²) (I)
where R¹═H or CH₃ and R²═H or linear, branched or cyclic, saturated or unsaturated alkyl radicals having 1 to 30 carbon atoms.

Monomers employed with very great preference in the sense of the general structure (I) include acrylic and methacrylic esters with alkyl groups consisting of 4 to 18 carbon atoms. Specific examples of such compounds, without wishing to be restricted by this enumeration, include n-butyl acrylate, n-pentyl acrylate, n-hexyl acrylate, n-heptyl acrylate, n-octyl acrylate, n-nonyl acrylate, lauryl acrylate, hexadecyl acrylate, stearyl acrylate, stearyl methacrylate, behenyl acrylate, branched isomers thereof, such as 2-ethylhexyl acrylate, isooctyl acrylate, isodecyl acrylate and tridecyl acrylate, and also cyclic monomers such as cyclohexyl acrylate, tetrahydrofurfuryl acrylate, dihydrodicyclopentadienyl acrylate, 4-tert-butylcyclohexyl acrylate, norbornyl acrylate and isobornyl acrylate, for example.

Likewise possible for use as monomers are acrylic and methacrylic esters containing aromatic radicals, such as phenyl acrylate, benzyl acrylate, phenyl methacrylate, benzyl methacrylate, phenoxyethyl acrylate, ethoxylated phenol acrylate or ethoxylated nonylphenol acrylate, for example.

A further possibility, optionally, is to use vinyl monomers from the following groups: vinyl esters, vinyl ethers, vinyl halides, vinylidene halides, and vinyl compounds containing aromatic rings or heterocycles in α position. For the vinyl monomers which may optionally be employed mention may be made, by way of example, of selected monomers which can be employed in accordance with the invention: vinyl acetate, vinylcaprolactam, vinylformamide, vinylpyridine, ethyl vinyl ether, 2-ethylhexyl vinyl ether, butyl vinyl ether, vinyl chloride, vinylidene chloride, acrylonitrile, styrene and α-methylstyrene.

Further monomers which can be employed in accordance with the invention are glycidyl methacrylate, glycidyl acrylate, allyl glycidyl ether, 2-hydroxyethyl methacrylate, 2-hydroxyethyl acrylate, 3-hydroxypropyl methacrylate, 3-hydroxypropyl acrylate, 4-hydroxybutyl methacrylate, 4-hydroxybutyl acrylate, acryloylmorpholine, methacryloylmorpholine, trimethylolpropane formal monoacrylate, propoxylated neopentyl methyl ether monoacrylate, tripropylene glycol methyl ether monoacrylate, ethoxylated ethyl acrylate such as ethyl diglycol acrylate, propoxylated propyl acrylate, acrylic acid, methacrylic acid, itaconic acid and its esters, crotonic acid and its esters, maleic acid and its esters, fumaric acid and its esters, maleic anhydride, methacrylamide and N-alkylated derivatives such as N-methylolmethacrylamide, acrylamide and N-alkylated derivatives such as N-methylolacrylamide, vinyl alcohol, 2-hydroxyethyl vinyl ether, 3-hydroxypropyl vinyl ether and 4-hydroxybutyl vinyl ether.

In the case of synthetic or other rubber as starting material for the pressure-sensitive adhesive in the at least one pressure-sensitive adhesive layer which can be employed optionally, there are further possibilities for variation, whether from the group of the natural rubbers or the synthetic rubbers or whether from any desired blend of natural rubbers and/or synthetic rubbers, it being possible in principle to select the natural rubber or natural rubbers from all available grades such as, for example, crepe, RSS, ADS, TSR or CV grades, depending on the required purity level and viscosity level, and to select the synthetic rubber or synthetic rubbers from the group of randomly copolymerized styrene-butadiene rubbers, butadiene rubbers, synthetic polyisoprenes, butyl rubbers, halogenated butyl rubbers, acrylate rubbers, ethylene-vinyl acetate copolymers and polyurethanes and/or blends thereof.

Tackifying resins which can be employed optionally in the at least one pressure-sensitive adhesive layer include, without exception, all known tackifier resins and tackifier resins described in the literature. Representatives which may be mentioned include rosins, their disproportionated, hydrogenated, polymerized and esterified derivatives and salts, the aliphatic and aromatic hydrocarbon resins, terpene resins and terpene-phenolic resins. Any desired combinations of these and further resins may be employed in order to adjust the properties of the resultant adhesive in accordance with requirements.

As plasticizers which can likewise be employed optionally it is possible to use all plasticizing substances known from the technology of self-adhesive tapes. They include, among others, the paraffinic and naphthenic oils, (functionalized) oligomers such as oligobutadienes and oligoisoprenes, liquid nitrile rubbers, liquid terpene resins, vegetable and animal fats and oils, phthalates and functionalized acrylates. Pressure-sensitive adhesives as indicated above may also include further constituents such as additives with a rheological activity, catalysts, initiators, stabilizers, compatibilizers, coupling reagents, crosslinkers, antioxidants, other ageing inhibitors, light stabilizers, flame retardants, pigments, dyes, fillers and/or expandants.

The at least one optional pressure-sensitive adhesive layer typically has a weight per unit area of between 2 g/m² and 500 g/m² inclusive, preferably between 5 g/m² and 100 g/m² inclusive.

The products produced in accordance with the invention preferably include at least one base sheet. This at least one base sheet may have been obtained from, in principle, all film-forming and extrudable polymers. In this regard see, for example, the compilation by F Nentwig [J. Nentwig, Kunststofffolien [Polymeric films], chapter 5, 2nd ed., 2000, C. Hanser, Munich, p. 97 ff]. Preferred base sheets of this kind are based advantageously on polyolefins. Preferred polyolefins are prepared from ethylene, propylene, butylene and/or hexylene, it being possible in each case to polymerize the single monomers or to copolymerize mixtures of the stated monomers. Through the polymerization process and through the selection of the monomers it is possible to control the physical and mechanical properties of the polymer sheet, such as the softening temperature and/or the tensile strength, for example.

A further possibility is to use polyvinyl acetates. As well as vinyl acetate, polyvinyl acetates may also contain vinyl alcohol in comonomer form, the free alcohol fraction being variable within wide limits. Another possibility is to use polyesters as the basic material of the at least one base sheet. One particularly preferred version of this invention uses polyesters based on polyethylene terephthalate (PET), for example. Furthermore, polyvinyl chlorides (PVC) can be used as basic sheet material. In order to raise the temperature stability it is possible to prepare the polymer constituents of these sheets using stiffening comonomers. The sheets may also be radiation-crosslinked in order to obtain a similar improvement in properties. Where PVC is used as raw sheet material, it may optionally include plasticizing components (plasticizers). Polyamides can be used for producing sheets, as well. The polyamides may be composed of a dicarboxylic acid and a diamine or of two or more dicarboxylic acids and diamines. Besides dicarboxylic acids and diamines, higher polyfunctional carboxylic acids and amines as well could be used, both alone and in combination with the aforementioned dicarboxylic acids and diamines. To rigidify the sheet it is preferred to use cyclic, aromatic or heteroaromatic starting monomers. Moreover, polymethacrylates can be used for producing sheets. Here it is possible to control the glass transition temperature of the sheet through the choice of the monomers (methacrylates and in some cases acrylates as well). The polymethacrylates may further comprise additives as well, in order for example to increase the sheet's flexibility or to raise or lower the glass transition temperature, or to minimize the formation of crystalline segments. Furthermore, polycarbonates can be used for producing sheets. A further possibility is to use polymers and copolymers based on vinyl aromatics and vinyl heteroaromatics to produce the at least one base sheet B.

The at least one base sheet may selectively be present, in particular, in monoaxially oriented, biaxially oriented or unoriented form.

To produce a sheet-form material it may be appropriate to add additives and further components which enhance the film-forming properties, which lower the tendency toward formation of crystalline segments and/or specifically improve the mechanical properties or else, where appropriate, impair the said properties. Further additives for optional use which may be present include ageing inhibitors, light stabilizers such as UV protectants in particular, antioxidants, other stabilizers, flame retardants, pigments, dyes and/or expandants.

The at least one base sheet may be employed itself as a monolayer construction, or else as a multilayer composite, obtained for example by coextrusion. The base sheet may additionally have been pretreated and/or provided with a functional layer on one or both sides. Where both sides have been pretreated and/or coated, the nature and/or extent of the pretreatment and/or coating may be different or the same. Such pretreatment and/or coating may serve, for example, for improved anchorage of a further layer, such as the at least one pressure-sensitive adhesive layer or the at least one varnish layer, for example, or other layers which may optionally be used. For this purpose it is particularly advantageous if one or both sides of the base sheet are pretreated with one kind or with different kinds of primers and/or if one or both sides of the base sheet are pretreated by corona and/or flame and/or plasma treatment and/or by other methods of surface activation.

The at least one layer of a base material typically has a thickness of between 5 μm and 500 μm inclusive, preferably between 10 μm and 100 μm inclusive.

The processes of the invention encompass the coating and curing of preferably radiation-curable formulations from which the at least one abrasion-resistant and flexible varnish layer is obtained. Varnish formulations of this kind preferably include at least one compound which carries at least one (meth)acrylate function, preferably at least two (meth)acrylate functions, and also, preferably, at least one compound which carries at least two (meth)acrylate functions, preferably three (meth)acrylate functions. Using further compounds with at least one (meth)acrylate function, preferably with higher (meth)acrylate functionality, is advantageous for the purposes of this invention.

Where compounds are employed which carry only one (meth)acrylate function it is preferred for the purposes of this invention to use (meth)acrylate monomers which have already been stated as monomers for pressure-sensitive adhesives of the at least one pressure-sensitive adhesive layer, and particularly those conforming to the general structural formula (I). In addition it is possible to use aliphatic or aromatic, especially ethoxylated or propoxylated polyether mono(meth)acrylates, aliphatic or aromatic polyester mono(meth)acrylates, aliphatic or aromatic urethane mono(meth)acrylates or aliphatic or aromatic epoxy mono(meth)acrylates as compounds which carry a (meth)acrylate function.

As compounds which carry at least two (meth)acrylate functions it is preferred to use one or more compounds from the list encompassing difunctional aliphatic (meth)acrylates such as 1,4-butanediol di(meth)acrylate, 1,6-hexanediol di(meth)acrylate, dipropylene glycol di(meth)acrylate, tricyclodecanedimethylol di(meth)acrylate, trifunctional aliphatic (meth)acrylates such as trimethylolpropane tri(meth)acrylate, tetrafunctional aliphatic (meth)acrylates such as ditrimethylolpropane tetra(meth)acrylate, pentafunctional aliphatic (meth)acrylates such as dipentaerythritol monohydroxypenta(meth)acrylate, and hexafunctional aliphatic (meth)acrylates such as dipentaerythritol hexa(meth)acrylate.

Additionally, if higher polyfunctionalized compounds are employed, it is possible to use aliphatic or aromatic, especially ethoxylated and propoxylated, polyether (meth)acrylates having in particular two, three, four or six (meth)acrylate functions, such as ethoxylated bisphenol A di(meth)acrylate, polyethylene glycol di(meth)acrylate, propoxylated trimethylolpropane tri(meth)acrylate, propoxylated glycerol tri(meth)acrylate, propoxylated neopentyl glycerol di(meth)acrylate, ethoxylated trimethylolpropane tri(meth)acrylate, ethoxylated trimethylolpropane di(meth)acrylate, ethoxylated trimethylolpropane tri(meth)acrylate, tetraethylene glycol di(meth)acrylate, ethoxylated neopentyl glycol di(meth)acrylate, propoxylated pentaerythritol tri(meth)acrylate, dipropylene glycol di(meth)acrylate, ethoxylated trimethylolpropane methyl ether di(meth)acrylate, aliphatic or aromatic polyester (meth)acrylates having in particular two, three, four or six (meth)acrylate functions, aliphatic or aromatic urethane (meth)acrylates having in particular two, three, four or six (meth)acrylate functions, and aliphatic or aromatic epoxy (meth)acrylates having in particular two, three, four or six (meth)acrylate functions. A further possibility is to make advantageous use of polyunsaturated vinyl ethers.

The processes of the invention may be used advantageously, moreover, to coat and to cure varnish formulations which include at least one kind of inorganic oxides in particulate form. The surface of these particles is preferably functionalized such that the particles not only form a stable suspension in the organic matrix formed by the varnish resin mixture, but also can be chemically linked during the curing operation with the organic network as it forms. Surface functionalization of this kind is accomplished with particular advantage by reacting the particles with coupling reagents such as, in particular, unsaturated silanes or titanates. In this regard see, for example, L. N. Lewis, D. Katsamberis, J. Appl. Polym. Sci., 1991, 42, 1551, EP 1 366 112 B1 of Hansechemie or U.S. Pat. No. 6,136,912 of Clariant SA. Such formulations with particular advantage include amorphous silicas or corundum whose average particle diameters are typically below 100 nm. Advantageous particle contents are up to 50% by weight, preferably up to 30% by weight.

Raw materials which can be used with advantage for the purposes of this invention are available for example under the brand names Highlink® from Clariant (C. Vu, 0. LaFerté, A. Eranian, Eur. Coat. J., 2002, 1-2, 64) and Nanocryl® from Hansechemie (C. Roscher, Eur. Coat. J., 2003, 4, 38).

Formulations of the invention from which the at least one abrasion-resistant and flexible varnish layer is produced advantageously include, in a fraction of up to 50% by weight, polymers having a molar mass of at least 5000 g/mol. Where such materials are employed, then in one advantageous version of the invention they are substantially free from reactive groups such as, in particular, C—C double bonds. In a further advantageous version such polymers carry functional groups, such as (meth)acryloyl groups for example, which are able to participate in the curing reaction. Particularly appropriate polymers include (meth)acrylate copolymers, but also other saturated or unsaturated polymers (see, for example, P. K. T. Oldring (ed.), Chemistry & Technology of UV & EB Formulations for Coatings, Inks & Paints, Vol. 2, 1991, SITA, London, pp. 158-184]. Polymers can be employed with advantage when they are soluble in a mixture with the other varnish resin components.

The processes of the invention can also be used with advantage to coat and cure varnish formulations which additionally, optionally but advantageously, comprise further constituents such as catalysts, accelerants, light stabilizers such as UV protectants in particular, ageing inhibitors, antioxidants, further stabilizers, flame retardants, flow control agents, wetting agents, lubricants, defoamers, devolatilizers, adhesion promoters, further rheological additives such as thixotropic agents, for example, matting agents and/or further fillers.

In one special version of the invention the formulations of the invention from which the at least one abrasion-resistant and flexible varnish layer is obtained are free from silicone-containing additives.

Where versions of this invention are employed in which the varnish formulation, after coating, is cured by electromagnetic radiation, and in particular in this case by UV radiation, at least one kind of a photoinitiator is added to the varnish formulation.

Suitable representatives of such photoinitiators are type I photoinitiators, in other words α-cleaving initiators such as benzoin derivatives and acetophenone derivatives, benzyl ketals or acylphosphine oxides, type II photoinitiators, in other words hydrogen abstractors such as benzophenone derivatives and certain quinones, diketones and thioxanthones. A further possibility is to use triazine derivatives to initiate free-radical reactions.

Photoinitiators of type I which can be employed with advantage include, for example, benzoin, benzoin ethers such as benzoin methyl ether, benzoin isopropyl ether, benzoin butyl ether and benzoin isobutyl ether, for example, methylolbenzoin derivatives such as methylolbenzoin propyl ether, 4-benzoyl-1,3-dioxolane and its derivatives, benzyl ketal derivatives such as 2,2-dimethoxy-2-phenylacetophenone or 2-benzoyl-2-phenyl-1,3-dioxolane, α,α-dialkoxyacetophenones such as α,α-dimethoxyacetophenone and α,α-diethoxyacetophenone, α-hydroxyalkyl phenones such as 1-hydroxycyclohexyl phenyl ketone, 2-hydroxy-2-methyl-1-phenylpropanone and 2-hydroxy-2-methyl-1-(4-isopropylphenyl)propanone, 4-(2-hydroxyethoxy)phenyl-2-hydroxy-2-methyl-2-propanone and its derivatives, α-aminoalkylphenones such as 2-methyl-1-[4-(methylthio)phenyl]-2-morpholinopropan-2-one and 2-benzyl-2-dimethylamino-1-(4-morpholinophenyl)butan-1-one, acylphosphine oxides such as 2,4,6-trimethylbenzoyl-diphenylphosphine oxide and ethyl 2,4,6-trimethylbenzoylphenylphosphinate, and O-acyl α-oximino ketones.

Photoinitiators of type II which can be employed with advantage include, for example, benzophenone and its derivatives such as 2,4,6-trimethylbenzophenone or 4,4′-bis(dimethylamino)benzophenone, thioxanthone and its derivatives such as 2-isopropylthioxanthone and 2,4-diethylthioxanthone, xanthone and its derivatives, and anthraquinone and its derivatives.

Type II photoinitiators are used with particular advantage in combination with nitrogen-containing coinitiators, known as amine synergists. For the purposes of this invention it is preferred to use tertiary amines. Furthermore, hydrogen atom donors are employed advantageously in combination with type II photoinitiators. Examples of such donors are substrates which contain amino groups. Examples of amine synergists are methyldiethanolamine, triethanolamine, ethyl 4-(dimethylamino)benzoate, 2-n-butoxyethyl 4-(dimethylamino)benzoate, iso-octyl 4-(dimethylamino)benzoate, 2-(dimethylamino-phenyl)ethanone, and unsaturated and hence copolymerizable tertiary amines, (meth)acrylated amines, unsaturated, amine-modified oligomers and polymers based on polyester or polyether, and amine-modified (meth)acrylates.

It is additionally possible to use polymerizable photoinitiators of type I and/or type II.

For the purposes of this invention it is also possible to use any combinations of different kinds of type I and/or type II photoinitiators.

After the coating and curing of the invention, the products of the invention have at least one abrasion-resistant and flexible varnish layer which has a preferred weight per unit area of between 0.5 g/m² and 50 g/m² inclusive, preferably between 2 g/m² and 15 g/m² inclusive.

The at least one abrasion-resistant and flexible varnish layer preferably has a hardness as determined by test B of at least 4H, preferably at least 7H, and a flexibility such that it passes test C.

The at least one abrasion-resistant and flexible varnish layer preferably has an extremely low surface roughness. Varnish layers of the invention exhibit a surface roughness by test D, given by the Rz value, of not more than 0.3 μm, preferably not more than 0.15 μm, very preferably not more than 0.08 μm. The at least one abrasion-resistant and flexible varnish layer is notable, as it were, for particularly high optical quality. Thus the at least one abrasion-resistant and flexible varnish layer is preferably transparent. In this version of the invention it has a test E transmittance of 400 nm, 600 nm and 800 nm of at least 85%, preferably at least 90%, very preferably at least 92%.

Furthermore, the products exhibit an at least abrasion-resistant and flexible varnish layer C having a particularly low turbidity, given by a haze value, determined according to test F, of not more than 5%, preferably not more than 2.5%, very preferably not more than 1%.

The preferably self-adhesive products produced via the processes of the invention comprising at least one optional pressure-sensitive adhesive layer, at least one base sheet and at least one abrasion-resistant and flexible varnish layer can be incorporated into the composite in any desired order in time. Processes in accordance with the invention include, for example, those in which a preliminary material containing at least the one base sheet is coated with the at least one optional pressure-sensitive adhesive layer. This can also be done by transfer lamination of the pressure-sensitive adhesive layer located on a release material. Subsequently the formulation from which the at least one varnish layer is obtained by curing is then coated onto the preliminary material which has already been provided with the at least one optional pressure-sensitive adhesive layer. A further possibility, for example, is first to coat a preliminary material containing at least the one base sheet with the formulation from which the at least one varnish layer is obtained by curing. Subsequently the preliminary material already provided with the varnish layer is provided with the at least one optional pressure-sensitive adhesive. This can be done by coating of a pressure-sensitive adhesive or by lamination of a ready-produced pressure-sensitive adhesive film.

Between the layers of the at least one optional pressure-sensitive adhesive layer and the at least one base sheet there may be an arbitrary number of further layers of like or different kind. Similarly, between the at least one abrasion-resistant and flexible varnish layer and the at least one base sheet there may also be an arbitrary number of further layers of like or different kind. Examples that may be mentioned of such further layers include layers of laminating adhesive, further base sheets, foamed layers, barrier layers, primer layers and/or layers by means of which—themselves and/or in combination with further layers—light may be reflected, without wishing to be restricted by this enumeration. Such layers which can be employed optionally may likewise be incorporated into the composite in any desired order in time which the construction of the product permits.

The preferably single-sidedly self-adhesive products of the invention are preferably provided on the site of the at least one pressure-sensitive adhesive layer with a release film or release paper, which is removed before the product is applied to the desired substrate.

The cover sheet can be removed at any point in time after the at least one curing step. In one preferred version of this invention, its removal is accomplished before the coated sheet-form substrate is wound. The sheet web can be converted in line or after being wound up into bales. Converting can take place by a variety of methods. Examples of such methods include slitting operations and diecutting operations, via which, for example, single-sidedly self-adhesive tapes, sheets or labels are obtained.

These methods are preferably used to produce single-sidedly self-adhesive products of high optical quality which on the non-adhesive side carry an abrasion-resistant and flexible layer, and which have been produced by way of the processes of the invention. Depending on embodiment they can be employed advantageously, for example, as self-adhesive tapes, sheets or labels for decorative purposes, as surface protection or as information-carrying articles.

Products produced by the process of the invention that are employed for decorative purposes comprise decorative elements for example, but preferably in the form of printing, which is located on any layer of the composite material of the invention beneath the at least one abrasion-resistant and flexible varnish layer. Decorative elements may, for example, be patterns of any kind. It is also possible for the purposes of this invention for at least one arbitrary layer of the composite material of the invention to be white, grey, black or coloured. If the said at least one layer is coloured, it may additionally and selectively be transparent or non-transparent. Preferably self-adhesive products of this kind are employed preferably in the form of self-adhesive sheets, cut into any desired shapes, in order to provide any desired substrates with the corresponding decoration contained in the product. If, for example, the product is coloured and transparent, then it can be used to provide glazing systems with colour in a simple way. The at least one abrasion-resistant and flexible varnish layer ensures in that case that the visual impression, such as, for example, the gloss of the surface, if the varnish has been formulated thus, is preserved over a relatively long period of time, in spite of mechanical stress, than would be the case in a comparative product without a protecting varnish layer. Similarly, any desired components, including surface-mounted automotive components or parts of cars, can be overstuck with sheets of the invention and hence made white, grey, black or coloured, for example, in a simple way, when the product of the invention is configured such that at least one layer of the inventive composite is white, grey, black or coloured. As a result of the at least one optional pressure-sensitive adhesive layer the product of the invention can readily be applied to any substrate. This enumeration can be understood only as an example of the inventive use of products according to the invention. A multiplicity of further design possibilities and uses are likewise possible.

Products produced by the process of the invention and carrying information contain this information for example, but preferably, in the form of printing, which is located on any layer of the composite material of the invention beneath the at least one abrasion-resistant and flexible varnish layer. Information may be, in particular, any combinations of alphanumeric symbols, bar codes, logos and/or patterns of any kind. Other kinds of information are likewise possible for the purposes of this invention. Such self-adhesive products are employed preferably as self-adhesive labels, cut to size or diecut into any shapes, for the purpose of imparting the corresponding information in the product to any desired substrate. The at least one abrasion-resistant and flexible varnish layer ensures in this case that the legibility of the information is preserved over a longer period of time, in spite of mechanical stress, than would be the case in a comparative product without a protecting varnish layer. As a result of the at least one optional pressure-sensitive adhesive layer the product of the invention is readily applied to any desired substrate. Again, the applications specified here for information-carrying products are to be understood only as examples. A multiplicity of further design possibilities and uses are likewise possible.

Products produced by the process of the invention that offer the capacity for data storage comprise this data storage capacity in or on any layer of the composite material of the invention. Data storage is possible in particular in the form of holograms, which can be written to and/or read from the corresponding layer by means of a laser. Such data may be, in particular, any desired combinations of alphanumeric symbols, bar codes, logos and/or patterns of any kind. Further kinds of data are likewise possible for the purposes of this invention. Data may additionally be stored, in the single-sidedly self-adhesive products, in the form of individual holograms, individual microtexts, individual microscripts and/or individual images, it being possible for the individual holograms to contain as data not only digital information but also microtexts, microscripts and/or microimages. Self-=adhesive products of this kind are employed preferably as self-adhesive labels, cut to size or diecut into any shapes, for the purpose of imparting data present in the product, and/or the capacity to write data to the product, to any desired substrate. The at least one abrasion-resistant and flexible varnish layer in this case ensures that the legibility and/or writeability of data is or are preserved over a longer period of time, in spite of mechanical stress, than would be the case in a comparative product without a protecting varnish layer. As a result of the at least one optional pressure-sensitive adhesive layer, the product of the invention can be applied readily to any desired substrates. Again, the applications of data-carrying products that are specified here are to be understood only as examples. A multiplicity of further design possibilities and uses are likewise possible.

Test Methods

Test A: Weight of Varnish Per Unit Area

A circular cutter was used to cut five test specimens A from a coated sample, and the total weight was determined by weighing. As a reference, a circular cutter was used likewise to cut five test specimens B from uncoated raw material, and the total weight was determined by weighing. The weights of varnish per unit area is one fifth of the difference between the total weight of the five test specimens A and the total weight of the five test specimens B. The weight per unit area is reported in g/m².

Test B: Pencil Hardness of Varnish

The pencil hardness of the varnish was determined in accordance with ASTM D3363. A varnish-coated test specimen is placed on a flat, smooth, firm surface, with the varnish pointing upwards. The hardness test was carried out using a set of pencils of different hardness (from 9B, the softest, to 9H, the hardest) of the Derwent Graphic Pencils type from Derwent, United Kingdom. The individual pencils were sharpened prior to each test.

The points were then flattened at an angle of 90°, using Superflex KJ-RR 16-I P600 sandpaper from Saint-Gobain Gerva B. V., so that a circular area was formed at the beginning of the lead. Pencils of different hardness were drawn by the tester over the test surface in succession, at an angle of 45°. The varnish is assigned the pencil hardness corresponding to the hardest pencil which just leaves no visible track in the varnish. If the hardest pencil (9H) does not score the varnish, the result is reported as >9H.

Test C: Flexibility of Varnished Product

A coated specimen is folded in an angle of 180° around the two closely adjacent side edges of a flat, burr-free metal tape of a defined thickness and an examination is made as to whether the varnish layer ruptures or flakes off in the region of maximum bending. For this purpose a Horex® feeler gauge strip from Preisser with a thickness of 100 μm is used. The specimen is placed firmly around the two edges in such a way that the air inclusions in the edge region are no longer visible to the eye. During the test, the varnish is located on the side of the composite which does not point to the feeler gauge strip. If the varnish withstands this stress, the test result is reported as a “pass”. If the varnish ruptures under this stress or undergoes flaking from a bottom layer, the result of the test is reported as a “fail”.

Test D: Surface Roughness of the Cover Sheet and of Varnish Layer C

The surface roughness of the cover sheet and of the cured varnish layer C is determined using a perthometer PGK from Mahr, equipped with an MFW250 feeler tip. The samples are cut into test specimens measuring approximately 10 cm×10 cm, and fastened to the measuring plate by magnets. The conical feeler tip is moved carefully towards the specimen so that it is just in contact with the surface of the specimen. The lateral measuring range is ±25 μm. The feeler tip is then run over the test specimen in a straight line over a distance of 1.75 mm at a speed of 0.1 mm/s, and in the course of this operation any vertical deflections are recorded and used to construct a vertical profile.

From the raw data, the surface roughness is evaluated in accordance with DIN EN ISO 4287 as the greatest height of the profile Rz. Three measurements are carried out in each case, in the direction of coating, and the average of the individual measurements is stated in μm.

Test E: Transparency of the Cover Sheet and of Varnish Layer C

A specimen of the cover sheet is cut such that it can be measured within a twin-beam UVIKON 923 UVNIS spectrophotometer from Bio-Tek Kontron Instruments. The transmittance is measured at a wavelength of 400 nm. The reference used is air. The transmittance is reported as a percentage of the irradiated light intensity.

To investigate the transparency of varnish layer C a slide of the kind used in optical microscopy (from Paul Marienfeld GmbH & Co KG, Lauda-Konigshofen, for example) is coated with a weight of 5 μm with the varnish formulation under investigation and intended to form varnish layer C, and is subsequently cured. The transmittance is measured in a UVNIS spectrophotometer of the aforementioned type, at wavelengths of 400 nm, 600 nm and 800 nm. The reference used is an uncoated slide of the same kind as that referred to above. For each measurement wavelength, the transmittance is reported as a percentage of the irradiated light intensity.

Test F: Turbidity of Varnish Layer C and of the Cover Sheet (Haze)

To determine the turbidity, or haze, of varnish-coated test specimens or of the cover sheet, the principle of the Ulbricht sphere was employed. A getSphere-80 measuring sphere from getSpec was used. The light source employed was an HL2000 halogen lamp from Mikropack. Prior to the measurement, calibration was carried out using a perfect diffuser (white reference, getSpec) and a perfect reflector (optical mirror). The reflection spectrum was recorded in the entire visible range and evaluated at 650 nm. The haze is reported as a % of the irradiated intensity.

### EXAMPLES

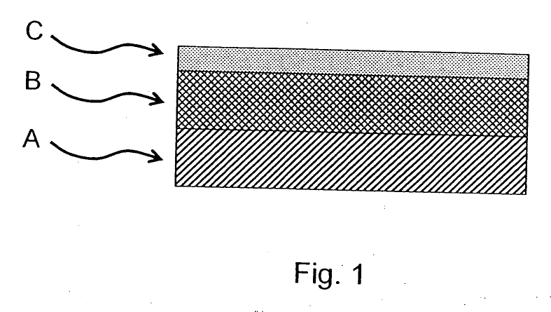

The processes of the invention are employed in particular for producing single-sidedly self-adhesive products which comprise at least one pressure-sensitive layer A, at least one base sheet B and at least one abrasion-resistant and flexible varnish layer C. FIG. 1 shows the construction of an exemplary but not exclusive embodiment of such products. The at least one pressure-sensitive adhesive layer A, whose use is optional, constitutes the bottommost layer in the composite, while the at least one abrasion-resistant and flexible varnish layer is the topmost layer. The at least one base sheet is located between these two layers.

The processes of the invention for producing preferably single-sidedly self-adhesive products include a coating step, in which the varnish formulation from which the at least one varnish layer C is produced is coated onto a preferably sheet-form material, a step during which the coated preliminary material is covered with a protective sheet of the invention, and at least one curing step. In one very preferred version of this invention these steps are carried out in line, i.e. in operating steps which follow one another continuously.

### Example 1

A radiation-curable varnish formulation which as well as other ingredients included a difunctional acrylate, a trifunctional acrylate and a photoinitiator was coated by means of a 0 doctor knife (wire doctor knife with a wire diameter of 0.05 mm from RK Print Coat Instruments) onto a single-sidedly self-adhesive polyester sheet 50 μm thick, and this coating was covered with an inventively selected 50 μm polyester sheet by lamination using a rubber roller. The polyester sheet used for covering had a test E transparency at 400 nm of 86% and a test D surface roughness on the side pointing towards the varnish of 0.025 μm. The haze value of the sheet was 0.38%. The composite was subsequently cured through the cover sheet with UV radiation (dose=25 mJ/cm² UV-C; Hg lamp, undoped, Eltosch). The cover sheet was subsequently removed without destruction or residue. The varnish layer showed no traces of coating evident to the eye, was fully cured, and had a test A weight per unit area of 2.8 g/m² and a test B pencil hardness of 6H. The flexibility of the varnish according to test C was determined with the result “pass”. The varnish layer had a test D surface roughness of Rz=0.027 μm, a test E transparency of 99.0% at 400 nm, 99.6% at 600 nm and 99.9% at 800 nm wavelength, and a test F haze value of 0.32%.

### Comparative Example 1

A varnish-coated specimen was produced using the materials (formulation, substrate) and procedure specified in Example 1. However, the specimen was not covered with a sheet and was irradiated in an exposed configuration. The dose was again 25 mJ/cm² UV-C (radiation apparatus as per Example 1). The varnish layer showed distinct traces of coating in the direction of coating, and was not fully cured. The weight per unit area, pencil hardness, flexibility, surface roughness and optical properties of this specimen were not tested.

### Comparative Example 2

A varnish-coated specimen was produced using the materials (formulation, substrate) and procedure specified in Example 1. However, the specimen was covered with a polyethylene sheet and irradiated. The polyethylene sheet used had a test E transparency at 400 nm of 69% and a surface roughness on the side pointing towards the varnish, according to test D, of 0.34 μm. The haze value was 23.6%. The composite was then cured through the cover sheet using UV radiation (dose=25 mJ/cm² UV-C, Hg lamp undoped, Eltosch). The cover sheet was then removed without residue or destruction. The varnish layer showed no coating traces evident to the eye, was fully cured, and had a test A weight per unit area of 2.2 g/m² and a test B pencil hardness of 6H. The flexibility of the varnish was determined by test C with the result “pass”. The varnish layer had a test D surface roughness of Rz=0.32 μm.

As the inventive example and the comparative examples show, single-sidedly self-adhesive products of high optical quality, provided with an abrasion-resistant and flexible varnish layer, are obtainable by a process according to the invention, but not by processes of the prior-art kind. In the absence of the inventive use of a cover sheet of the invention (Comparative Example 1), the atmospheric oxygen present prevents curing of the varnish layer. Comparative Example 2, in contrast, illustrates that, although the use of an arbitrary cover sheet, in this case a polyethylene sheet which is not inventive with respect to surface roughness and optical properties, does lead to a varnish layer which is sufficiently cured and no longer exhibits any traces of coating, it is unable to produce the demanding surface quality requirements in the microscopic region. The use of a cover sheet of the invention, in contrast, guarantees both: the efficient curing of the varnish layer, and its high optical surface quality.

1. Process for producing versatile plastic products, comprising the steps of:
a) providing a base material coated with a protective layer in the form of a curable liquid varnish formulation,
b) covering the base material with a cover layer exhibiting a surface roughness at least to the varnish side, with an Rz value of not more than 0.3 μm, and/or a turbidity with a haze value of not more than 5%,
c) curing the varnish layer through the cover layer, and
d) detaching the cover layer.

2. Process according to claim 1, the base material is sheet-form and is pretreated and/or possesses at least one further functional layer.

3. Process according to claim 1, wherein the plastic products are present in webs with a working width of at least 30 cm.

4. Process according to claim 1, wherein the plastic products have adhesive layers, which are applied selectively to the end product or to a preliminary product.

5. Process according to claim 4, wherein the plastic products have at least one adhesive layer on one side beneath the base layer.

6. Process according to claim 1, wherein the cover layer is laminated on.

7. Process according to claim 1, wherein a cover sheet is married at high and equal speed to, and pressed against, a sheet-form base material provided with a varnish coating.

8. Process according to claim 1, wherein the base material is obtained from film-forming and extrudable polymers.

9. Process according to claim 8, wherein the base material is provided in monoaxially oriented, biaxially oriented or unoriented form and is used as a monolayer construction, as a multilayer composite or as a laminate, and may have been pretreated and/or provided with at least one functional layer on one or both sides, identically or differently.

10. Process according to claim 1, wherein the base material is based on polyolefins, polyvinyl acetates, polyesters, polyvinyl chlorides, polyamides, polymethacrylates and/or blends thereof, to which further additives and/or components which tailor the properties are optionally added.

11. Process according to claim 1, wherein the base materials, varnish formulations and also optional adhesive layers and any further functional layers are brought in any order into a composite.

12. Process according to claim 1, wherein the base material has a layer thickness of 5 Nm to 500 μm.

13. Process according to claim 1, wherein the coating of the base material with a curable varnish formulation takes place by means of knife-coating, blade, roller, spray, dip, brush, casting and printing methods.

14. Process according to claim 1, wherein the varnish formulation is a radiation-curable formulation and curing takes place radiation-chemically.

15. Process according to claim 14, wherein the varnish formulation comprises compounds which possess at least one (meth)acrylate function, optionally in a mixture with at least one compound which carries at least two (meth)acrylate functions.

16. Process according to claim 14, wherein the varnish formulation comprises one or more inorganic oxides in particulate form which are functionalized such that in the course of curing they form a stable suspension in the organic matrix and/or are chemically linked to the organic network as it forms, optionally with a particle content of up to 50% by weight.

17. Process according to claim 16, characterized in that the particles are amorphous silica or corundum whose particle diameters are below 100 nm.

18. Process according to claim 13, wherein the varnish formulation has up to 50% by weight of soluble polymers having a molar mass of at least 5000 g/mol which are optionally free from C—C double bonds.

19. Process according to claim 13, wherein the varnish formulation is free from silicone-containing additives.

20. Process according to claim 13, wherein the varnish layer after coating and curing has a weight per unit area of 0.5 g/m² to 50 g/m².

21. Process according to claim 13, wherein at least one photoinitiator is added to the varnish formulation for UV radiation curing.

22. Process according to claim 1, wherein the cover layer has a surface roughness at least to the varnish side with an Rz value of not more then 0.15 μm.

23. Process according to claim 1, wherein the cover layer has a haze value of not more than 2.5%.

24. Process according to claim 1, wherein the cover layer is based on polyolefins, polyvinyl acetates, polyesters, polymethacrylates, partly fluorinated or perfluorinated hydrocarbons, paper and/or mixtures thereof, to which further additives and/or components which tailor the properties are optionally added.

25. Process according to claim 1, wherein the cover layer possesses a defined transparency for radiation used for curing.

26. Process according to claim 25, wherein curing takes place by exposure to electromagnetic radiation, and/or particulate radiation.

27. Process according to claim 25, wherein the cover layer has a transparency of at least 80% for curing the varnish layer with UV radiation at an irradiated wavelength of 400 nm.

28. Process according to claim 251 wherein the cover layer has no transparency when curing with electron beams at an irradiated wavelength of 400 nm and in the visible region.

29. Process according to claim 1, wherein the cover layer has a layer thickness of 5 Nm to 150 Nm.

30. Process according to claim 1, wherein the cover layer in the form of a cover sheet is in monoaxially oriented, biaxially oriented or unoriented form and is used as a monolayer construction, as a multilayer composite or as a laminate, and may have been pretreated and/or provided with at least one functional layer on one or both sides.

31. Process according to claim 30, for the purpose of improved detachment the cover layer on the side pointing at least to the varnish possesses at least one coating which is based on polysiloxanes, partly fluorinated or perfluorinated polymeric carbon compounds or polyolefins, and/or in that it has been modified by corona, flame and/or plasma treatment.

32. Process according to claim 1, wherein the cover layer at least on the side facing the varnish layer is free from inorganic and/or particulate antiblocking agents.

33. Plastic products with surfaces which possess high abrasion resistance, flexibility and optical transparency, produced-according to the process of claim 1.

34. (canceled)

35. The plastic product according to claim 33, which is in the form of a decorative, information-carrying or data-containing sheet or coated substrate.

36. Product according to claim 35, wherein the substrate is an automotive component or a part of cars.

37. Product according to claim 33, which is in the form of a self-adhesive sheet, tape or label.

38. Product according to claim 33, which is in the form of a decoration-bearing, information-carrying and/or data-containing self-adhesive tape, sheet or label.

39. Product according to claim 39, which is for storing individual holograms, microtexts, microscripts and/or images, the data content of said individual holograms including not only digital information but also microtexts, microscripts and/or microimages.

40. Product according to claim 38, which is for fixing decoration, information and/or data on packaging, products, components, automotive parts or parts of cars.

41. An automobile, automobile part, decoration or package comprising a product according to claim 33.
